(19) United States
(12) Patent Application Publication
(10) Pub. No.: US 2024/0339892 A1
(43) Pub. Date: Oct. 10, 2024

(54) VEHICLE SUSPENSION ENERGY RECLAMATION GENERATOR

(71) Applicant: Larry D. Armstrong, Eufaula, OK (US)

(72) Inventor: Larry D. Armstrong, Eufaula, OK (US)

(21) Appl. No.: 18/747,828

(22) Filed: Jun. 19, 2024

Related U.S. Application Data
(63) Continuation-in-part of application No. 18/166,456, filed on Feb. 8, 2023.

(51) Int. Cl. H02K 7/18; B60L 53/57; F16D 41/069; H02K 7/02

(52) U.S. Cl. CPC H02K 7/1853; H02K 7/02; B60L 53/57; F16D 41/069

(57) ABSTRACT

A system is disclosed and illustrated for converting vertical movement of a vehicle in motion into electrical energy using at least one example embodiment having a vertically-collapsible frame with a frame bias spring to expand the frame to a normal height under a predetermined weight. The frame mounts between a shortened suspension spring and the vehicle's chassis, so that it is compressed when the vehicle bounces up and down during travel. A shaft to an electrical generator is rotated by at least one, and preferably two, sprag clutch drives responsive to the collapsing and re-expanding of the frame. The generator output is available for storage in a battery to be used by an electric motor or electric accessories. Optional fly weights can be used to keep generator shaft rotation relatively constant during transition between collapsing and re-expanding phases, and vice versa.

### RELATED APPLICATIONS

The present application is a continuation-in-part of U.S. patent application Ser. No. 18/166,456 and titled “Vehicle Suspension Energy Reclamation Generator” with filing date of Feb. 8, 2023, which is incorporated herein in their entirety and referenced thereto.

### BACKGROUND OF THE INVENTION

The push to make vehicles more fuel efficient has been ongoing since the beginning of self-powered vehicles. Today, fossil-fuel-only vehicles include hundreds of improvements to the engine, transmission, exhaust and body design to improve their fuel efficiency. So-called hybrid vehicles combine one or more electric motors and a fossil fueled engine and typically reclaim kinetic energy through regenerative braking and batteries. Plug-in hybrid vehicles allow charging of the on-board batteries from an external power source. Electric vehicles (EVs) do not have a a fossil-fueled motor, and rely entirely on charging the batteries from an external power source and regenerative braking. Despite these advances, vehicles of all sorts remain less efficient than the theoretical maximum.

### SUMMARY OF THE INVENTION

A system is disclosed and illustrated for converting vertical movement of a vehicle in motion into electrical energy using at least one example embodiment having a vertically collapsible frame with a frame bias spring to expand the frame to a normal height under a predetermined weight. The frame mounts between a shortened suspension spring and the vehicle's chassis, so that it is compressed when the vehicle bounces up and down during travel. A shaft to an electrical generator is rotated by at least one, and preferably two, sprag clutch drives responsive to the collapsing and re-expanding of the frame. The generator output is available for storage in a battery to be used by an electric motor or electric accessories. Optional fly weights can be used to keep generator shaft rotation relatively constant during transition between collapsing and re-expanding phases, and vice versa.

### BRIEF DESCRIPTION OF DRAWINGS

The figures presented herein, when considered in light of this description, form a complete disclosure of one or more embodiments of the invention, wherein like reference numbers in the figures represent similar or same elements or steps.

FIG. 1 depicts an example generator device using at least one sprag drive according to at least one embodiment of the present invention.

FIG. 2 shows an example embodiment of a collapsible frame according to at least one embodiment of the present invention.

FIG. 3 illustrates the three horizontal plates of an example frame according to at least one embodiment of the present invention.

FIG. 4 shows an example housing for a portion of the generator according to at least one embodiment of the present invention.

FIG. 5 shows an alternative mounting configuration according to at least one embodiment of the present invention.

FIG. 6 illustrates another mounting configuration for the biasing spring of the present disclosure.

FIG. 7 sets forth a functional block diagram according to at least one embodiment of the present invention.

### DETAILED DESCRIPTION OF THE INVENTION

There is a need to benefit from unneeded vehicle movement during transit providing a source of energy which need not be wasted by being expended in the vehicle's suspension system. Vertical movement of the vehicle due to wind, road imperfections, turning and braking is undesirable as it is uncomfortable for the person(s) driving and riding in the vehicle, and may damage freight or goods being carried by the vehicle. The present inventor has realized that most vehicle types, including fossil-fuel-only, hybrid, plug-in hybrid and EV, have very similar suspension systems. Each wheel is typically outfitted with at least one suspension spring (a thick, hard to compress wound spring capable of holding up about a quarter of the weight of the vehicle and its maximum payload) with a piston-based shock absorber in parallel with each other. Each of these provides part of the suspension function—the spring returns the car to its normal position after a bump or bounce, and the shock absorber reduces the residual bouncing of the spring to help it settle into its normal position more quickly. Together, the suspension springs and shock absorbers (dampers) form a low pass filter which blocks the higher frequency road noise (mechanical noise) from being transmitted from the road to the vehicle frame.

With the advent of additional suspension components which can be controlled by software executed by on-board microcontrollers, the traditional all-mechanical suspension systems have come to be known as “passive suspensions,” and the newer systems with some software-controlled components are referred to as “active suspensions.” Active suspensions allow the on-board microcontroller to stiffen or soften the suspension dynamically, for ride preferences and for performance handling improvements. For example, some vehicles have active suspension systems which stiffen the suspension over the right front wheel when steering to the left at high speeds and stiffen the suspension over the left front wheel when steering to the right at high speeds to prevent the outside front wheel from “diving” down during a hard, fast turn. Diving causes the inside rear wheel to have less pressure on it, and therefore, less traction, which can lead to drift and slide of the vehicle. So, the active suspension feature improves cornering handling and ride comfort (riders experience less tilt towards the outside of the turn).

While many cars of all the types of fuel sources share these suspension mechanisms and features, the present inventor has realized that much of the energy “absorbed” by the suspension system is simply dissipated, and therefore wasted. This is a combination of energy which was stored during acceleration into kinetic energy and regenerative, and its dissipation by the suspension system results in heat from friction in the dampers and/or distortion (compression and stretching) of the springs. The present inventor has set out to design one or more systems which recapture this otherwise-lost energy, putting that energy back into a storage system which then can be converted back into kinetic energy by an appropriate motor matching the storage system.

The present invention is described in the following paragraphs using an example embodiment which includes electrical generation, electric battery energy storage, and electric motor system for converting to useful kinetic energy. Those ordinarily skilled in the arts will recognize that analogous means exist for embodiments of the invention to utilize air pressure, oil pressure and other forms of energy capture, storage and release.

In a first example embodiment, the system is designed to collect energy from the vertical movement of a vehicle in motion from an access point of the suspension springs. Most suspension springs are designed and “sized” (e.g., force level required to compress them) so that they compress 2″ to 5″ during normal operation under normal payload amounts of the vehicle. This example embodiment replaces the typical suspension spring with one which is a few inches (2″-5″) shorter in its normal (uncompressed, unstretched) state, but otherwise, the replacement spring has the same strength as the original spring. In series with the replacement spring, such as on top of it (preferably), or optionally below it or even in the middle of two partial springs, is a collapsible and stretchable mechanism which, when collapsed and stretched under force by vertical movement of the vehicle, generates energy, such as electricity. This generator mechanism is designed to collapse and stretch under significantly less force than the force required to compress and stretch the replacement spring so that the generator mechanism is operated before the spring is engaged. In this manner, what can be considered the first few inches of suspension movement result in operation of the generator, not the springs, and subsequent additional inches of movement are filtered by the spring and shock absorber.

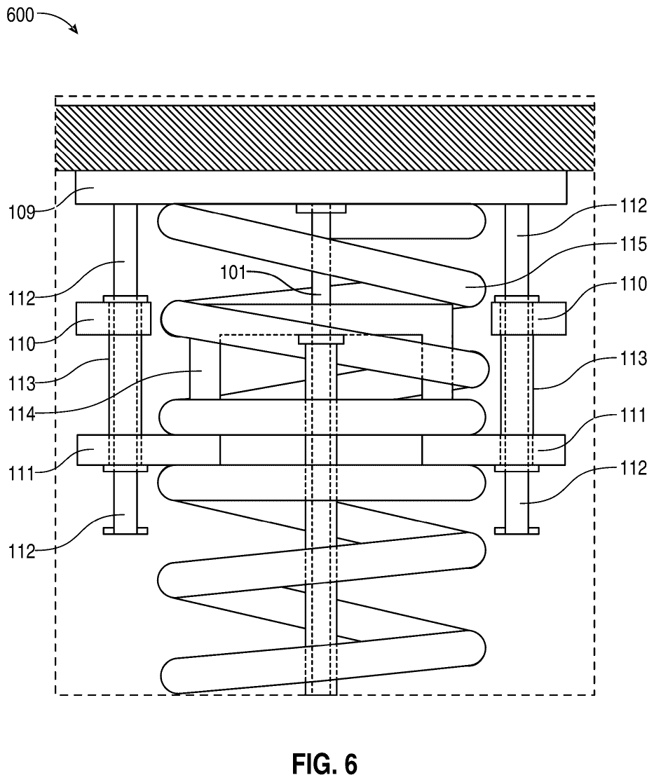

In the following paragraphs and drawing descriptions, the example embodiment will be shown in a coaxial configuration with the spring, such as being mounted inside the coil of the spring. However, those ordinarily skilled in the arts will recognize that other mechanical configurations will result in the same operational benefits, such as mounting the generator mechanism outside the spring, as illustrated in FIG. 6. Similarly, the following example embodiment shows a square or rectangular implementation, but round, oval and other shapes may be adopted with similar benefits of the invention. Further, it should be noted that the drawings are not shown to any particular scale.

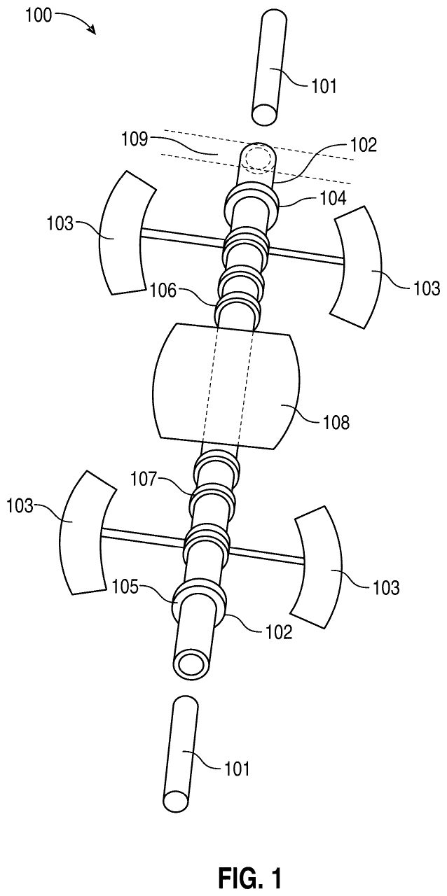

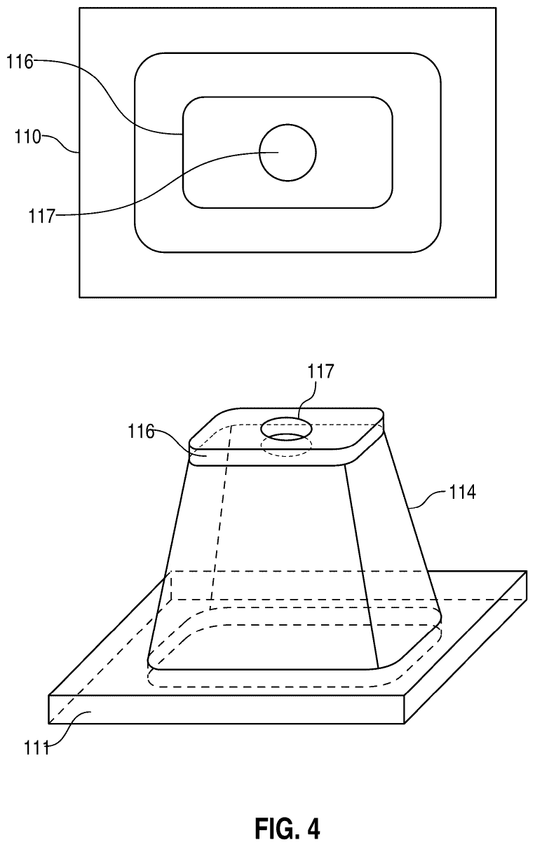

FIG. 1 details of an example embodiment 100 of a generator suitable for inclusion in the housing 114 and housing top 116 with orifice 117 for the sprag and generator rods, details of which are shown 400 in FIG. 4. In FIG. 1, the drive shaft 101 is received into the hollow generator shaft 102. The front bracket 104 is attached to upper plate 109. A rear bracket 105 attaches to plate 111. One-way spiral gear 106 and 107 on the generator drive shaft 102 spin the generator or alternator 108 in the same direction on both up strokes (expansion and decompression) and down strokes (compression and collapse) alike, via the sprag clutches. Weights and counter-weights 103 form a type a flywheel which stores rotational energy in the generator drive shaft to keep it spinning as the movement of the system transitions between collapse and expand and vice versa.

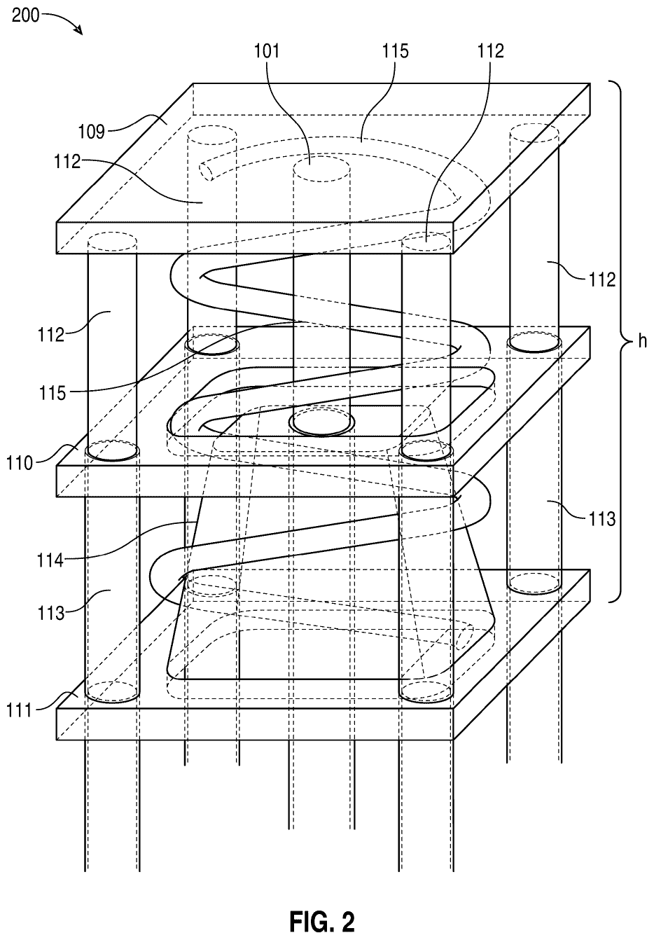

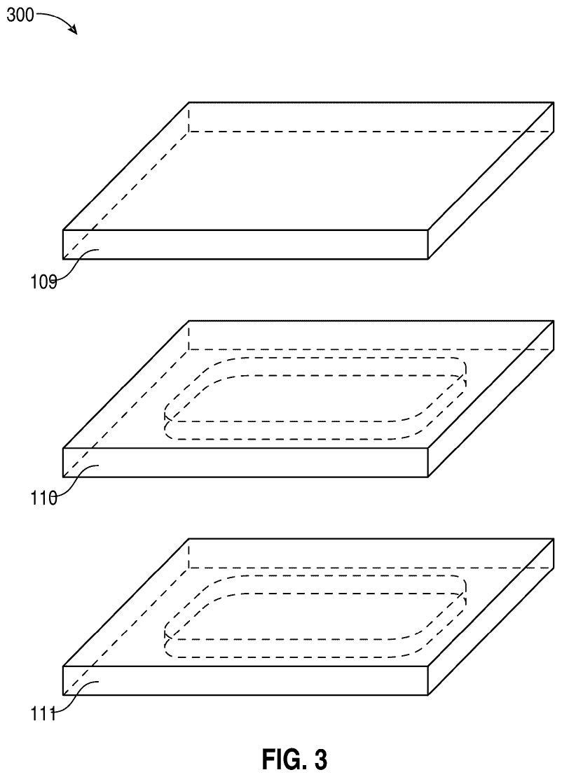

The example embodiment has three plates 109, 110 and 111, as shown 200 and 300 in FIGS. 2 and 3, respectively. The upper plate 109 is attached to the suspension of the vehicle (in configurations with the generator mechanism above the replacement spring) allowing it to move freely up and down in reference to center plate 110 through a series of guide bars 112 passing through a set of sleeves 113 when the vehicle is moving up and down. The lower plate 111 attaches to the top of the replacement suspension spring in this example top-mount configuration.

Internal to the three-plate generator frame formed by the guide bars, sleeves and plates is a biasing spring 115 (only a few segments are shown in FIG. 2 to reduce complexity of the figure) which is strong enough to hold the vehicle at its normal height prior to removal of (or replacement of) the original suspension spring. So, the biasing spring 115 also positions the three plates to “normal” (uncompressed, unstretched) height of the mechanism. Plates 110 and 111 have opening in the middle of them. Spring 115 rests on top of plate 111 and goes through plate 110, and is attached to the top of plate 109 as shown 200 in FIG. 2.

In this example embodiment, spring 115 has a lower coefficient for compression than the replacement suspension spring, which allows the mechanism to collapse under downward pressure before the replacement suspension spring appreciably compresses. In reality, the two springs collapse simultaneously; however, the generator spring will compress more inches than the replacement spring will compress by ratio of their strength coefficients until the generator spring is completely compressed.

As the vehicle bounces downward and spring 115 compresses, plate 109 will be forced down towards plate 110. As the vehicle bounces upwards and spring 115 expands or even stretches, the plates move away from each other, eventually settling back into the normal position when the vehicle is no longer in motion and no longer bouncing. As such, most of the initial 2″ to 5″ of suspension compression during operation will be received into the generator, and very little will be received into the replacement suspension spring.

In the vertical center of the generator in this configuration is a shaft 101, which can be forced down and through hollow generator rod 102 when the plates are moved towards each other, and the reverse as the plates are moved away from each other. Shaft 101 is of a sprag clutch design which is forced (during collapse operation) through hollow generator rod 102 which has a number of sprag clutches attached to a first set of clutches 106, and spins the shaft in a particular direction. As the generator spring 115 and/or vehicle movement forces the shaft back up to the normal, at-rest position (plates further apart), the second set of clutches 107 which are in reversed position of the first set of clutches 106 will spin shaft 102 in the same direction. In this manner, up and down movement (expansion and collapse) of the mechanism is rectified into a single direction of rotation of the generator shaft. During the turn-around time between up and down motions and between down and up motions, the generator preferably uses a flywheel or weight-counterweight system to keep the rod spinning, as will be discussed in the following paragraphs.

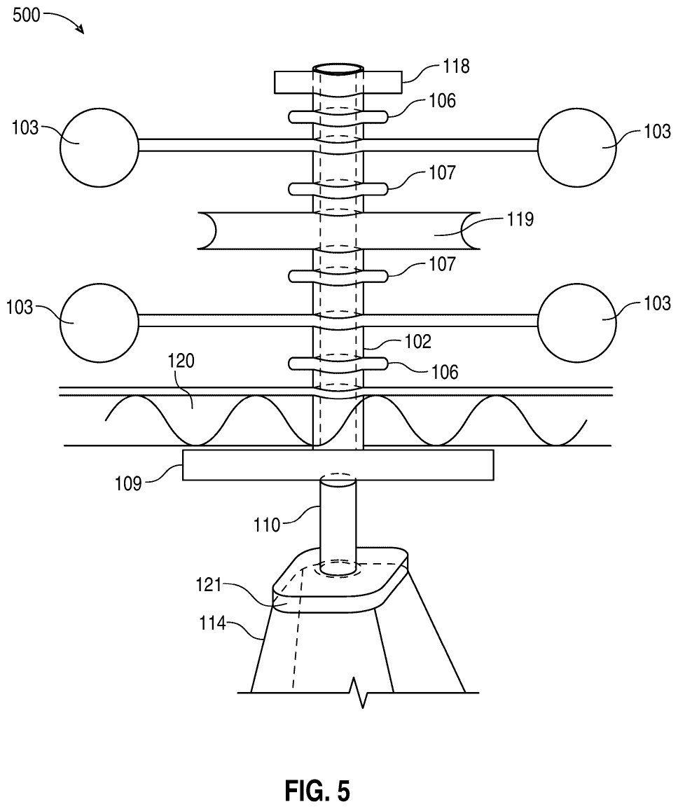

FIG. 5 illustrates another mounting configuration in which the sprag rods may pass through or past the vehicle suspension system, which is especially useful for applications where the generator system cannot fit into a shorter or narrower OEM spring height. In such a case, this can be configured by attaching rod 101 to the top on the plate 121 as shown 500, and plate 121 is a protruding part of plate 111 which is flush with the surface of plate 110 as shown 400 in FIG. 4. This would allow the sprag rod to be forced upward through the vehicle frame, spinning the generator rod 102 on top of the frame.

FIG. 6 illustrates another mounting configuration in which the biasing spring is mounted on the outside of the shortened suspension spring. This is done in order to allow more room for a larger generator or alternator in order to capitalize on the regenerative energy stored in the embodiment (mass) of the vehicle as it is in motion. The energy is absorbed by the system and method of the disclosed subject matter through the suspension spring. This energy is similar to the energy arising through a regenerative braking system and method. When the vehicle is in motion, the vibration energy is not produced. The regenerative braking process collects the energy once the vehicle moves or until the braking system operates to force the vehicle to stop or slow down. The present invention is designed to collect this regenerative energy being stored in the vehicle embodiment while the vehicle is in vibrational and vertical motion before the suspension spring can absorb it, or burn it up and turn it back into renewable energy.

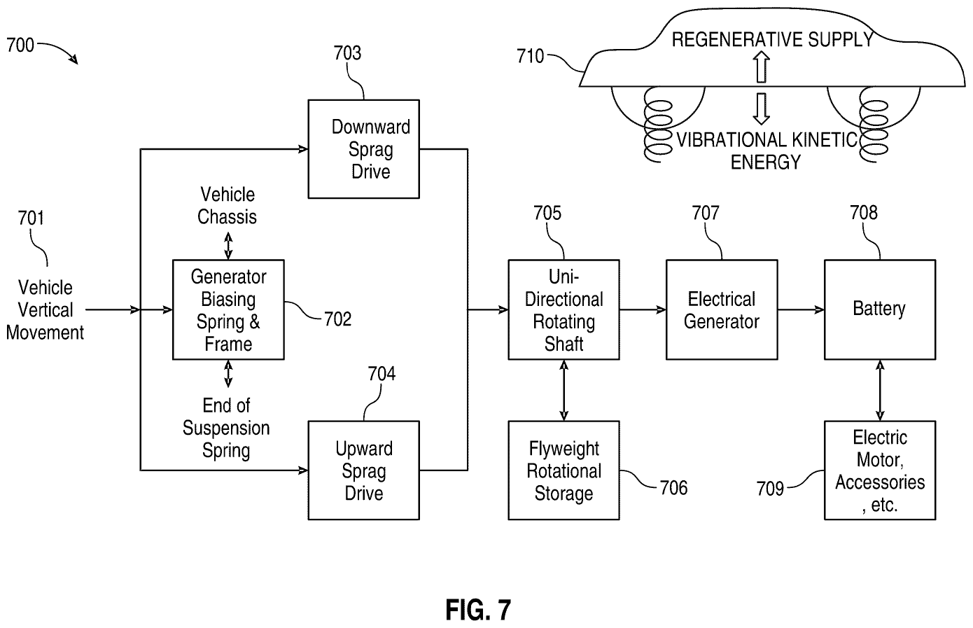

FIG. 7 provides a functional block diagram 700 of a system according to the present invention. Energy from the mechanical vertical motion GI of the vehicle is received into the system. The generator biasing spring and frame elements 702 work in series with the suspension spring to support between an axle and the vehicle chassis. The generator frame and biasing spring 702 may be, in various embodiments, above a shortened suspension spring, below a shortened suspension spring, in between two shortened suspension springs, or even beside a multi-stage suspension spring. In compression phases, the downward sprag drive 703 provides rotational force to spin a uni-directional spinning generator shaft 705. In expansion phases, the upward sprag drive 704 provides rotational force to spin a uni-directional spinning 705 generator shaft 705. The generator rotating shaft 705 operates an electrical generator 707, and the electrical current output of the generator is received into one or more batteries 708. Rotational energy is stored in the fly weights 706 (weights and counter-weights) to keep the shaft's rotating speed generally uniform. during transitions between upward and downward sprag drive phrases. The batteries can then be used to power one or more electric motors, accessories, brakes, active suspension components, etc., to offset and reduce the total energy consumption of the vehicle to increase its operational efficiency. As FIG. 7 further shows, the vibrational kinetic energy captured from automobile 710 provides the input to the generator for supplying the electrical current herein captured and power the above-stated electric motors and related components.

The terminology used herein is for the purpose of describing particular exemplary embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A system for converting vertical movement of a vehicle in motion into electrical energy, comprising:
a vertically-collapsible frame;
a frame bias spring configured to expand the frame to a normal height under a predetermined weight;
an electrical generator or alternator having a rotatable shaft input and an electrical current output, said electrical generator rotatable shaft rotating in response to collapsing of said vertically-collapsible frame to produce a varying electromagnetic field and, in response thereto, producing an electric current;
one or more mounts to mechanically attach the system between a vehicle chassis and a vehicle suspension system; and
at least drive mechanism configured to impart spinning motion on the rotatable shaft input of the generator or alternator responsive to at least one movement of the frame to collapse, to expand, or both to collapse and expand.

2. The system as set forth in claim 1 wherein said electrical generator associates with a regenerative energy braking system for providing said electric current to said regenerative energy braking in responses to said electric current.

3. The system as set forth in claim 1 wherein said system for converting vertical movement of a vehicle in motion into electrical energy.

4. The system as set forth in claim 1 wherein the frame bias spring has a spring rate less than a spring rate of an associated replacement suspension spring.

5. The system as set forth in claim 4 wherein the normal height plus a height of the associated replacement suspension spring are equal to a height of an original suspension spring to be replaced.

6. The system as set forth in claim 1 wherein the at least one drive mechanism comprises at least one sprag clutch drive.

7. The system as set forth in claim 6 wherein the at least one sprag clutch drive comprises at least a pair of sprag clutch drives which provide uni-directional drive in two directions of linear movement.

8. The system as set forth in claim 1 wherein the frame comprises at least three vertically aligned plates, and at least two collapsible vertical alignment rod-and-sleeve pairs.

9. A method of manufacture for a system to convert vertical movement of a vehicle in motion into electrical energy, comprising:
assembling a vertically-collapsible frame;
disposing a frame bias spring into the frame to expand the frame to a normal height under a predetermined weight;
disposing, into the frame, an electrical generator or alternator having a rotatable shaft input and an electrical current output, and configuring said for rotating said electrical generator rotatable shaft in response to collapsing of said vertically-collapsible frame to produce a varying electromagnetic field and, in response thereto, producing an electric current;
providing to the frame one or more mounts configured to mechanically attach the system between a vehicle chassis and a vehicle suspension system; and
providing to the frame and generator or alternator at least drive mechanism configured to impart spinning motion on the rotatable shaft input of the generator or alternator responsive to at least one movement of the frame to collapse, to expand, or both to collapse and expand.

10. The method as set forth in claim 1, further comprising the step of associating said electrical generator with a regenerative energy braking system for providing said electric current to said regenerative energy braking in responses to said electric current.

11. The method as set forth in claim 9 wherein the frame bias spring has a spring rate less than a spring rate of an associated replacement suspension spring.

12. The method as set forth in claim 11 wherein the normal height plus a height of the associated replacement suspension spring are equal to a height of an original suspension spring to be replaced.

13. The method as set forth in claim 9 wherein the at least one drive mechanism comprises at least one sprag clutch drive.

14. The method as set forth in claim 13 wherein the at least one sprag clutch drive comprises at least a pair of sprag clutch drives which provide uni-directional drive in two directions of linear movement.

15. The system as set forth in claim 9 wherein the frame comprises at least three vertically aligned plates, and at least two collapsible vertical alignment rod-and-sleeve pairs.
